(19) United States
(12) Patent Application Publication
(10) Pub. No.: US 2020/0306669 A1
(43) Pub. Date: Oct. 1, 2020

(54) DUST COLLECTION ATTACHMENT AND DUST COLLECTION SYSTEM FOR POWER TOOL

(71) Applicant: MAKITA CORPORATION, Anjo-shi (JP)

(72) Inventors: Yoshiro TADA, Anjo-shi (JP); Masanori FURUSAWA, Anjo-shi (JP)

(73) Assignee: MAKITA CORPORATION, Anjo-shi (JP)

(21) Appl. No.: 16/789,533

(22) Filed: Feb. 13, 2020

(30) Foreign Application Priority Data
Mar. 26, 2019 (JP) 2019-058952

(51) Int. Cl. B01D 29/72; B23Q 11/00; B25F 5/00; B23Q 17/00

(52) U.S. Cl. CPC B01D 29/72; B23Q 11/0046; B23Q 17/007; B23Q 11/0071; B25F 5/00

(57) ABSTRACT

The filter can receive timely dust removal in a reliable manner. A dust collection attachment connectable to a hammer drill includes a dust collection motor that generates a suction force, a filter that catches sucked dust, a solenoid that removes dust accumulating on the filter, and a dust collection controller that controls an operation of the dust collection motor and the solenoid and activates the solenoid when a predetermined condition is satisfied.

### CROSS-REFERENCE TO RELATED APPLICATIONS

This application claims the benefit of priority to Japanese Patent Application No.

2019-058952, filed on Mar. 26, 2019, the entire contents of which are hereby incorporated by reference.

### BACKGROUND

### 1. Technical Field

The present invention relates to a dust collection attachment connected to a power tool such as an electric drill and a hammer drill, and to a dust collection system for a power tool including the dust collection attachment.

### 2. Description of the Background

A power tool such as an electric drill or a hammer drill may be used in a dust collection system including a dust collection attachment to collect and store dust from a workpiece during machining such as drilling, as one such example is described in Japanese Unexamined Patent Application Publication No. 2018-69397. In such a known dust collection system, a dust collection fan included in the dust collection attachment is rotated by a dust collection motor to suck air including dust through a suction port at a tip of the tool. The air including dust then passes through a dust box inside the dust collection attachment, where it is caught by a filter inside the dust box and stored without scattering.

### BRIEF SUMMARY

In a known dust collection attachment, a filter clogged with accumulating dust decreases a suction force, lowering the dust collection efficiency. A known dust box thus includes a dust removal mechanism for removing the accumulating dust off the filter. However, the dust removal mechanism is to be activated by an operator when appropriate. This causes not only inconvenience but also a failure to use the dust removal mechanism before the filter is clogged. The dust removal mechanism thus may not be used properly.

One or more aspects of the present invention are directed to a dust collection attachment and a dust collection system for a power tool that allow a filter to receive timely dust removal in a reliable manner.

A first aspect of the present invention provides a dust collection attachment connectable to a power tool, the attachment including:
a dust collection motor configured to generate a suction force;
a filter configured to catch sucked dust;
a dust removal mechanism configured to remove dust accumulating on the filter; and
a control unit configured to control an operation of the dust collection motor and the dust removal mechanism, and activate the dust removal mechanism when a predetermined condition is satisfied.

A second aspect of the present invention provides a dust collection system for a power tool, the system including:
a power tool; and
the dust collection attachment connected to the power tool.

The dust collection attachment and the dust collection system for a power tool according to the above aspects of the present invention allow the filter to receive timely dust removal in a reliable manner.

### BRIEF DESCRIPTION OF DRAWINGS

FIG. 1 is a longitudinal central sectional view of a dust collection system.

FIG. 2 is a longitudinal central sectional view of a dust collection attachment.

FIG. 3 is a flowchart of control for the dust collection system.

FIG. 4 is a longitudinal central sectional view of a dust collection attachment according to a modification showing a dust removal mechanism.

FIG. 5 is a cross-sectional view taken along line A-A in FIG. 4.

### DETAILED DESCRIPTION

One or more embodiments will now be described with reference to the drawings.

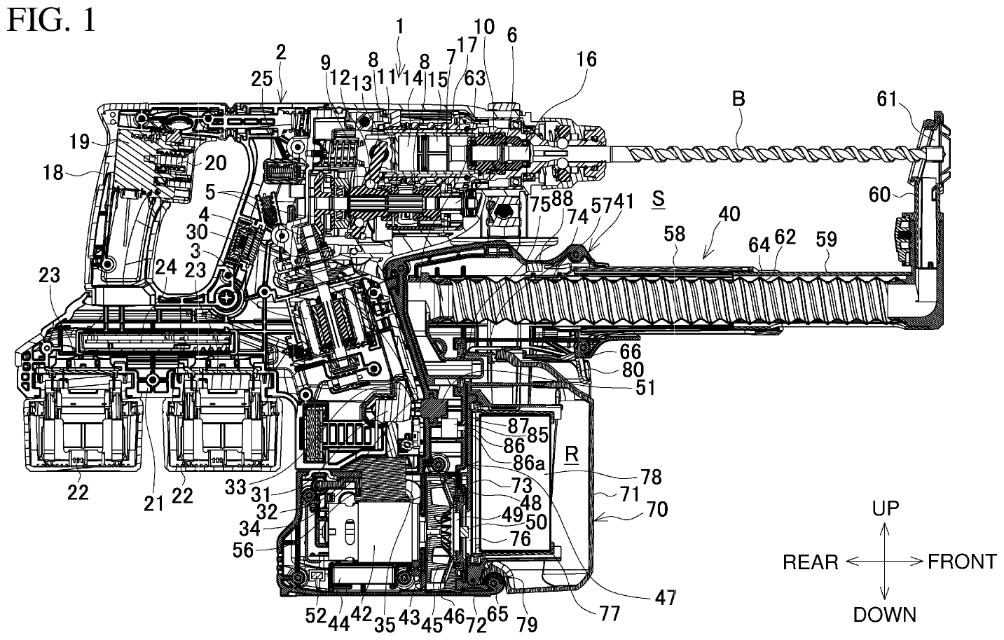

FIG. 1 is a longitudinal central sectional view of a dust collection system S including a hammer drill 1 (an example of a power tool) to which a dust collection attachment 40 is attached.

The hammer drill 1 includes a housing 2 and a motor (brushless motor) 3. The housing 2 includes a pair of right and left halves of the housing that are assembled together. The motor 3 is accommodated in a front lower portion of the housing 2 to have an output shaft 4 tilted rearward. A countershaft 6 is supported in the front-rear direction above the motor 3. The countershaft 6 receives a torque transmitted through a bevel gear 5. The countershaft 6 receives a first gear 7, a clutch 8, and a boss sleeve 9 in this order from the front. Above the countershaft 6, a tool holder 10 is axially supported in parallel with the countershaft 6. The tool holder 10 can hold a bit B at its distal end. A piston cylinder 11 is inserted through the rear of the tool holder 10 in a movable manner. The piston cylinder 11 receives an arm 13 connected at its rear end. The boss sleeve 9 externally holds the arm 13 with a swash bearing 12 with the axis tilted. The piston cylinder 11 contains a striker 15 across an air chamber 14 in a reciprocable manner. The striker 15 can strike an impact bolt 16 located in front of the striker 15. The first gear 7 meshes with a second gear 17 attached to the tool holder 10.

A handle 18 is located in a rear upper portion of the housing 2. The handle 18 includes a switch 19 and a switch lever 20. A battery mount 21 is located below the handle 18. The battery mount 21 receives two battery packs 22 aligned in the front-rear direction as a power supply. Each battery pack 22 is slide-attached in the lateral direction. The battery mount 21 internally includes terminal blocks 23. The terminal blocks 23 are electrically connected to the attached battery packs 22. A controller 24 is accommodated above the terminal blocks 23 to extend in the front-rear direction. The controller 24 is electrically connected to electric components including the motor 3, the switch 19, and the terminal blocks 23. The controller 24 includes a circuit board receiving, for example, a microcomputer and switching elements.

A wireless unit 25 is located on a right side surface of the housing 2 behind the countershaft 6. The wireless unit 25 is electrically connected to the controller 24. The wireless unit 25 can communicate, using a wireless communication technique such as Bluetooth (registered trademark), with an external dust collection device (not shown) that also has the wireless communication function.

The front lower portion of the housing 2 is an attachment portion 30. The attachment portion 30 has a front surface sloping downward, and protrudes in front of the battery packs 22. The attachment portion 30 receives the dust collection attachment 40. A female connector 31 is located below the motor 3 inside the attachment portion 30. The female connector 31 includes a female terminal for power supply and two female terminals for communication (three female terminals in total) arranged in the lateral direction. An insertion opening 32 is formed in the front surface of the attachment portion 30 in front of the female connector 31. The female connector 31 is supported in a manner swingable about its rear end in the up-down direction. The female connector 31 is urged to the lowermost position by a torsion spring (not shown) to allow an upper shutter 33 to close the insertion opening 32. A pressing bar 34 is located below the female connector 31 in a manner movable upward and downward. The pressing bar 34 protrudes toward the lower surface of the attachment portion 30 at the lowermost position of the female connector 31. A lower recess 35 is located at the lateral center of the lower surface of the attachment portion 30. The lower recess 35 is open frontward and downward. The pressing bar 34 protrudes in the lower recess 35. The two side surfaces of the attachment portion 30 on the right and left of the lower recess 35 each have a guide groove (not shown) extending in the front-rear direction. The guide grooves receive the dust collection attachment 40 in a slidable manner.

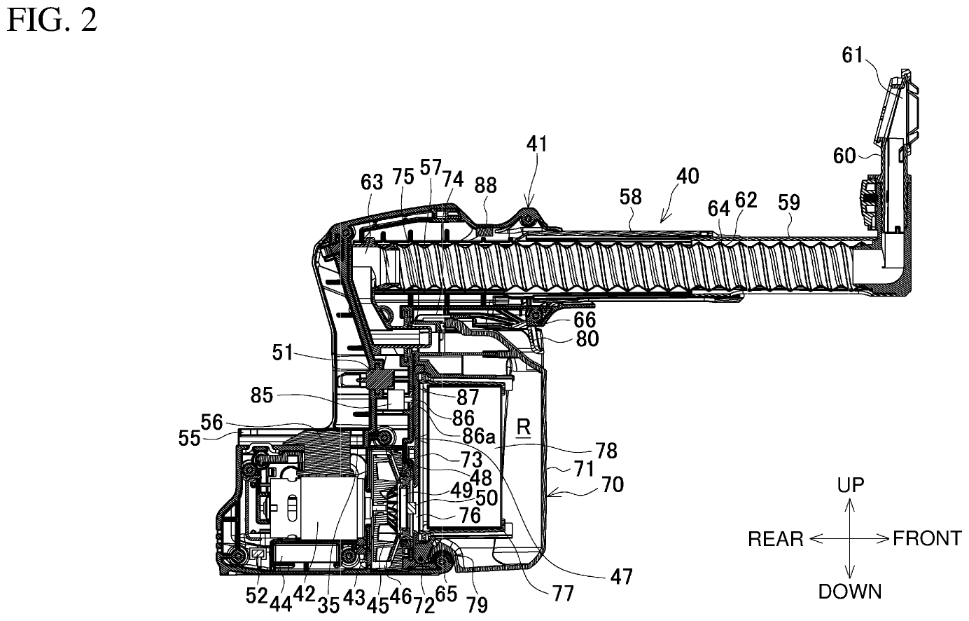

The dust collection attachment 40 includes a pair of right and left halves of a casing that are assembled together as shown in FIG. 2. The dust collection attachment 40 includes a casing 41. A rear upper portion of the casing 41 is fitted with the attachment portion 30 of the hammer drill 1. A rear lower portion of the casing 41 accommodates a dust collection motor 42. The dust collection motor 42 includes an output shaft 43 facing frontward. A dust collection controller 44 is located below the dust collection motor 42. A dust collection fan 45 is fastened to the output shaft 43. The dust collection fan 45 is accommodated in an air inlet chamber 46. The air inlet chamber 46 is a compartment defined in the casing 41, and has an air outlet (not shown) in its side surface. The casing 41 includes a connecting portion 47 at its front lower surface for a dust box 70. The connecting portion 47 is in front of the air inlet chamber 46 and recedes to have a front opening. A partition 48 behind the connecting portion 47 serving as the bottom of the connecting portion 47 has a communication hole 49. The communication hole 49 is coaxial with the dust collection fan 45, and connects the connecting portion 47 and the air inlet chamber 46. The communication hole 49 receives a pressure sensor 50 for detecting the pressure of air flowing through the communication hole 49. The pressure sensor 50 is electrically connected to the dust collection controller 44.

A male connector 51 is located on an upper rear surface of the casing 41. The male connector 51 includes three plate-like male terminals for power supply and for communication. The male terminals protrude rearward.

An indicator lamp 52 is located on a rear side surface of the casing 41. The indicator lamp 52 is electrically connected to the dust collection controller 44. The indicator lamp 52 prompts cleaning of the dust box 70 including the filter 78 or replacement of the filter 78 by using different lighting patterns. When pressed, the indicator lamp 52 is turned off.

A pair of guide rails 55 (FIG. 2) are located on the right and left on a rear upper surface of the casing 41. The guide rails 55 extend in the front-rear direction, and can be fitted in the guide grooves on the right and left surfaces of the attachment portion 30. The rear upper surface of the casing 41 includes an upward pressing member 56 between the guide rails 55. The upward pressing member 56 has a rear surface sloping downward. When the attachment portion 30 is fitted, the upward pressing member 56 enters the lower recess 35 and presses the pressing bar 34 upward.

In the casing 41, a guide passage 57 extends above the connecting portion 47 in the front-rear direction. The guide passage 57 has an open front end, and a rear end bent in a U shape to extend behind the connecting portion 47. The guide passage 57 holds a guide cylinder 58 protruding forward. A slide cylinder 59 is internally connected to the guide cylinder 58 in a manner movable in the front-rear direction. A nozzle 60 is connected to the front end of the slide cylinder 59. The nozzle 60 is L-shaped and has a tip upward. The nozzle 60 has a cylindrical suction port 61 in its tip. A bit B coaxially passes through the suction port 61.

The guide passage 57 and the slide cylinder 59 internally accommodate a flexible hose 62. The flexible hose 62 has a front end connected to the nozzle 60, and a rear end connected to a duct 63. The duct 63 is a cylinder bent in a U shape in conformance with the rear end shape of the guide passage 57. A spiral wire 64 is located integrally with the flexible hose 62 to urge the flexible hose 62 in an extension direction. The flexible hose 62 urges the nozzle 60 and the slide cylinder 59 forward. A lower end portion of the duct 63 passes through the partition 48, and protrudes inside the connecting portion 47. A receiving shaft 65 protrudes laterally at the lower end of the connecting portion 47 and in front of the partition 48. An engagement protrusion 66 is located at a frontward position on an upper inner surface of the connecting portion 47. The engagement protrusion 66 engages with an upper side of the dust box 70.

The dust box 70 includes a box body 71 and a lid 73. The box body 71 is a deep box having an opening rearward. The lid 73 is a vertically long rectangle, and is connected to a portion below the opening of the box body 71 with a hinge shaft 72 in a rotatable manner.

The lid 73 has an engagement tab 74 on its upper end. The engagement tab 74 is a loop that engages with the upper surface of the box body 71 in a closed state of the opening of the box body 71 and maintains the closed state. The lid 73 has a rectangular inlet 75 extending laterally on its upper end. The inlet 75 receives the lower end portion of the duct 63 when the lid 73 is attached to the connecting portion 47. The lid 73 has a circular outlet 76 on its lower end. The outlet 76 faces the communication hole 49 when the lid 73 is attached to the connecting portion 47.

A filter compartment 77 is located in front of the outlet 76 of the lid 73. The filter compartment 77 holds a paper filter 78 folded laterally with vertical folds. In this state, the tops of the vertical folds of the filter 78 are exposed at equal intervals in the lateral direction. The right and left sides of the filter 78 are also exposed inside the box body 71.

The lower surface of the box body 71 has a groove 79 to fit with the receiving shaft 65 for the connecting portion 47. An operation tab 80 is located on the upper surface of the box body 71 to elastically engage with the engagement protrusion 66 on the connecting portion 47.

A solenoid 85, which serves as a dust removal mechanism, is located under the male connector 51 and behind the partition 48. The solenoid 85 is electrically connected to the dust collection controller 44. The dust collection controller 44 controls the power supply to the solenoid 85 to intermittently advance the plunger 86 through a through-hole 87 to strike the lid 73. The plunger 86 includes a striking member 86a at its distal end. The through-hole 87 extends through the partition 48.

The casing 41 includes a dust removal switch 88 on its upper front surface. When pressed, the dust removal switch 88 causes the dust collection controller 44 to supply power to the solenoid 85 to intermittently advance the plunger 86.

The dust box 70 is placed, with the lid 73 rearward, to have an inclined posture with the groove 79 fitted with the receiving shaft 65 from the front. The lid 73 is then pressed into the connecting portion 47 to be raised upright with the operation tab 80 elastically engaged with the engagement protrusion 66, thus allowing attachment to the connecting portion 47. In the attached state, the duct 63 has its distal end fitted with the inlet 75 to protrude into the box body 71. The outlet 76 thus faces the communication hole 49 and communicates with the air inlet chamber 46. The dust collection attachment 40 defines an internal dust collection path R for sucking air through the suction port 61 and through the nozzle 60, the flexible hose 62, the duct 63, and the filter 78 in the box body 71 to the air inlet chamber 46.

In the dust collection system S according to the present embodiment, the dust collection attachment 40 is attached to the hammer drill 1 by first aligning the guide grooves on the attachment portion 30 with the guide rails 55 on the casing 41 to place the attachment portion 30 above the rear portion of the casing 41. The dust collection attachment 40 is then slid rearward to fit the casing 41 with the attachment portion 30 from the front. Thus, the guide rails 55 are fitted into the right and left guide grooves on the attachment portion 30 for connecting the attachment portion 30 with the guide rails 55. The upward pressing member 56 enters the lower recess 35 and presses the pressing bar 34 upward. This moves the shutter 33 upward to swing the female connector 31 to the uppermost position facing the insertion opening 32. The dust collection attachment 40 thus allows the male terminals of the male connector 51 to enter the housing 2 through the insertion opening 32. The male terminals are thus electrically connected to the female terminals of the female connector 31.

The suction port 61 is placed to abut against a target surface of a workpiece, and the switch lever 20 is pressed. The switch 19 is turned on to cause the controller 24 to drive the motor 3 and rotate the countershaft 6. A switching knob (not shown) on a side surface of the housing 2 is operated to slide the clutch 8 for selecting a drill mode, a hammer mode, or a hammer drill mode. In the drill mode, the clutch 8 is at a frontward position to mesh with the first gear 7 alone. In the hammer mode, the clutch 8 is at a rearward position to mesh with the boss sleeve 9 alone. In the hammer drill mode, the clutch 8 is at a middle position to mesh with the first gear 7 and the boss sleeve 9 at the same time.

In the drill mode, the tool holder 10 is rotated with the second gear 17 to rotate the bit B. In the hammer mode, the arm 13 swings to reciprocate the piston cylinder 11. The striker 15 is operated through the air chamber 14 in cooperation with the piston cylinder 11, and strikes the bit B with the impact bolt 16. In the hammer drill mode, the tool holder 10 rotates and the impact bolt 16 is struck at the same time.

Once the machining starts, the dust collection controller 44 drives the dust collection motor 42 to rotate the dust collection fan 45. The dust collection fan 45 rotates to suck the outside air through the suction port 61, which then passes through the nozzle 60, the dust collection path R, and the air inlet chamber 46 and is discharged outside through the air outlet. Thus, dust from the workpiece is sucked through the suction port 61, enters the dust box 70 through the nozzle 60, the flexible hose 62, and the duct 63, and passes through the filter compartment 77 and is caught by the filter 78 and stored in the box body 71.

The dust collection controller 44 monitors a suction force detected by the pressure sensor 50 during operation. When detecting a decrease in the suction force, the dust collection controller 44 turns on the indicator lamp 52 for indication and activates the solenoid 85 for a predetermined period (e.g., from a few seconds to several tens of seconds) to cause the plunger 86 to strike the lid 73 for vibrating the filter 78. This removes the accumulating dust off the filter 78. This is referred to as automatic dust removal.

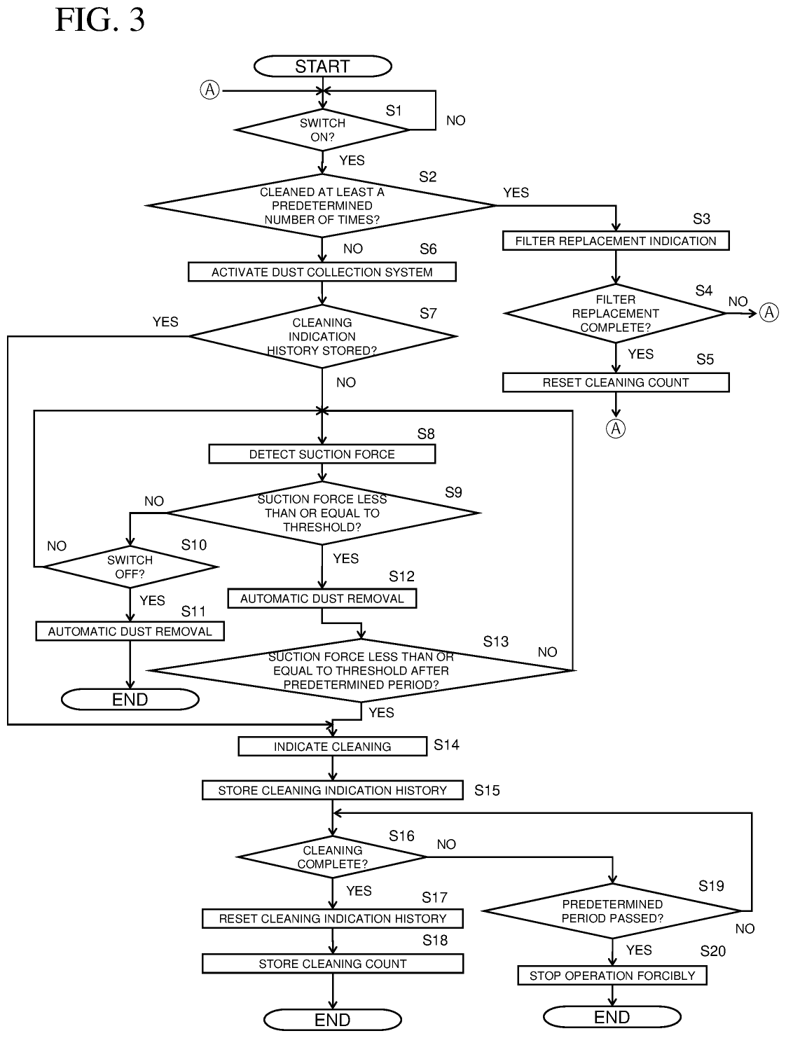

The dust collection controller 44 also stores the history of indications prompting to clean the dust box 70. When the indication count reaches a predetermined number, the dust collection controller 44 generates an indication prompting to replace the filter 78. The maintenance control will now be described with reference to a flowchart in FIG. 3.

In S1, the switch lever 20 is pressed to turn on the switch 19. In S2, the dust collection controller 44 determines whether the dust box 70 has been cleaned at least a predetermined number of times. For example, the number of times the indicator lamp 52 is turned off after the cleaning operation (ON operation count) corresponds to the cleaning count. When the cleaning count reaches the predetermined number, the filter 78 is determined to reach its service life end. In S3, the indicator lamp 52 flashes, prompting to replace the filter 78. The indicator lamp 52 remains flashing for a predetermined period after the switch 19 is turned off.

The operator slides the dust collection attachment 40 forward to detach it from the hammer drill 1 with the procedure reverse to the attachment of the dust collection attachment 40. In the dust collection attachment 40, the operation tab 80 is pressed down and disengaged from the engagement protrusion 66, and the dust box 70 is rotated about the receiving shaft 65 to have its upper portion pulled down forward, and is thus detached from the connecting portion 47. The engagement tab 74 on the lid 73 is disengaged from the box body 71 to open the lid 73, allowing replacement of the filter 78. To replace the filter 78, the dust box 70 alone may be detached without detaching the dust collection attachment 40 from the hammer drill 1.

In response to the indicator lamp 52 pressed by the operator after the filter 78 is replaced, the dust collection controller 44 detects the replacement of the filter 78 in S4. In S5, the dust collection controller 44 resets the cleaning count (ON operation count of the indicator lamp 52). To resume the operation, the possessing returns to S1. Without the filter 78 being replaced, or more specifically, without the indicator lamp 52 being pressed, the system will not start when the processing returns to S1 and the switch lever 20 is pressed.

When the cleaning count is determined to be less than the predetermined number in S2, the motor 3 and the dust collection motor 42 operate to activate the dust collection system S in S6. In S7, the determination is performed on whether the history is stored for cleaning indications by the indicator lamp 52 for prompting to clean the dust box 70. When no history of cleaning indications is stored, the pressure sensor 50 detects a suction force in S8. When the suction force exceeds a predetermined threshold in the determination in S9, the determination is performed on whether the switch 19 is off (operation complete) in S10.

When the switch 19 is on, the operation continues and the suction force remains detected as in S8. When the switch 19 is turned off, the solenoid 85 is energized to cause the plunger 86 to strike the lid 73, or to perform automatic dust removal, for a predetermined period in S11.

When the suction force is less than or equal to the threshold in the determination in S9, the solenoid 85 is energized to perform the automatic dust removal for a predetermined period in the same manner in S12. Subsequently in S13, after the automatic dust removal, the determination is performed on whether the suction force after a predetermined period remains less than or equal to the threshold. When the suction force exceeds the threshold, the processing returns to S8. When the suction force remains less than or equal to the threshold, the indicator lamp 52 lights, prompting to clean the dust box 70 including the filter 78. The indicator lamp 52 remains lighting for a predetermined period after the switch 19 is turned off. When the history of cleaning indications is found in the determination in S7, the dust box 70 is determined uncleaned, or more specifically, the indicator lamp 52 to indicate completion of the cleaning operation is determined unpressed. In S14, the operator is prompted to clean the inside of the dust box 70 in S14.

Subsequently in S15, the history of the cleaning indications is stored. In S16, the determination is performed on whether the cleaning is complete, or more specifically, whether the operator has cleaned the dust box 70 and pressed the indicator lamp 52. When the cleaning is determined complete, the dust collection controller 44 resets the history of cleaning indications in S17, and stores the cleaning count (ON operation count of the indicator lamp 52) in S18. Without the indicator lamp 52 being pressed in S16 for at least a predetermined period in S19, the dust collection controller 44 forcibly stops the motor 3 and the dust collection motor 42 in S20. This is indicated by the indicator lamp 52 with different patterns of flashing or a buzzer sound.

The dust collection controller 44 (system control unit) in the dust collection system S according to the present embodiment monitors the state of the dust collection attachment 40 to determine the time to perform maintenance. This allows the filter 78 to receive timely maintenance.

In particular, the dust collection controller 44 monitors the dust suction force in the dust collection attachment 40 (S9). This allows proper determination on the time to clean or replace the filter 78.

The dust collection controller 44 monitors the service life of the filter 78 (the cleaning count in S2). This allows more proper determination on the time to replace the filter 78.

The dust collection controller 44 indicates that the time to perform maintenance has come, and stops operating the motor 3 and the dust collection motor 42 when the indication is not reset (indicating the cleaning completion) within a predetermined period after the indication (S20). This restricts the use of the system without maintenance.

In addition, determining that the time to perform maintenance has come, the dust collection controller 44 activates the solenoid 85 (dust removal mechanism) in S11 or S12. This allows automatic dust removal from the filter 78, improving convenience.

In the control in FIG. 3, when the suction force is determined to remain lower after the dust removal in S13, the rotational speed of the dust collection motor 42 may be increased before an indication is provided for prompting to clean the dust box. When the suction force still remains lower, a cleaning indication may be generated. Increasing the rotational speed of the dust collection motor 42 can retain the dust collection function although much dust is stored or the filter 78 is clogged, thus allowing continuous operation.

The dust collection controller 44 may monitor the rotational speed or the current value of the dust collection motor instead of the suction force. The rotational speed of the dust collection motor increases linearly as the dust stored in the dust box increases. The current value of the dust collection motor decreases linearly as the dust stored in the dust box increases. The time to perform maintenance can thus be determined when the rotational speed or the current value reaches its predetermined threshold. The time to perform maintenance may also be determined by directly detecting the amount of dust in the dust box.

To determine the service life of the filter in accordance with the cleaning count, a predetermined number may be set in accordance with the performance of the filter. For example, a greater number than for a normal filter may be set for a high-performance filter, such as a high-efficiency particulate air (HEPA) filter. The determination on the time to perform maintenance (replacement) of the filter may be varied in accordance with the performance of the filter to allow appropriate maintenance in accordance with the performance of the filter. A filter with higher performance may collect more dust, which is to be discarded earlier, but the filter is to be cleaned or replaced later. A filter with lower performance works in the opposite manner.

A threshold for determining the suction force may also be varied in accordance with the performance of the filter. For example, a higher-performance filter may have a higher threshold.

To determine the service life of the filter, the driving time of the dust collection motor is measured as the filter use time, instead of the cleaning count. The time at which the cumulative driving time reaches a threshold may be determined as the time to perform maintenance.

The dust collection attachment may be used as a separate cleaner when including a power supply, such as a battery, and an activating switch. In this case as well, the dust collection controller can determine the time to perform maintenance in the same manner as in the embodiment.

In the dust collection attachment 40 and the dust collection system S according to the present embodiment, the dust collection controller 44 (control unit) activates the solenoid 85 (dust removal mechanism) when a predetermined condition is satisfied. The dust removal from the filter 78 can be performed reliably at an appropriate time.

In particular, the dust collection controller 44 activates the solenoid 85 in response to a decrease in the suction force below a predetermined value (S9) to allow dust removal from the filter 78 clogged.

The dust collection controller 44 also activates the solenoid 85 after the dust collection motor 42 is stopped (S10). This allows dust removal at the operation end to restore the suction force for any subsequent operation.

The solenoid 85 (dust removal mechanism) directly vibrates the filter 78 when energized, achieving effective dust removal.

The dust removal switch 88 can activate the solenoid 85 at an intended time, thus allowing the dust removal at an intended time and improving convenience.

The dust removal may be performed when the cleaning count reaches a predetermined number before filter replacement (the end of the service life), instead of when the suction force decreases or the operation ends as described in the embodiment. The dust removal performed in accordance with the remaining service life of the filter can extend the service life of the filter. The dust removal may also be performed immediately after the switch is turned on and before the motor is driven.

The drive time of the dust collection motor may be monitored as the filter use time, instead of the cleaning count. The dust removal may be performed when the drive time reaches a predetermined time indicating the remaining service life.

The remaining service life may also be determined in accordance with the rotational speed or the current value of the dust collection motor to perform the dust removal.

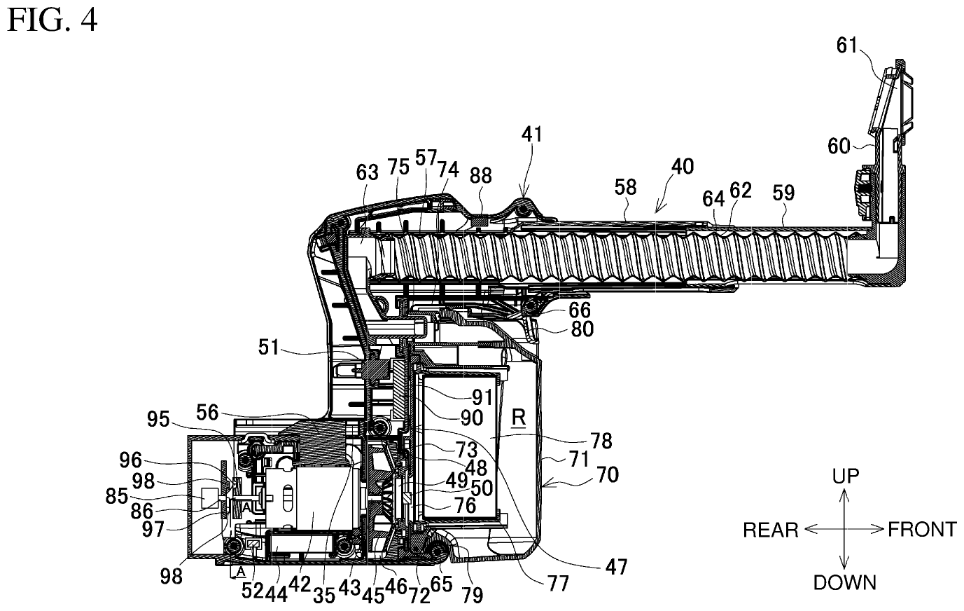

In the example shown in FIG. 4, the partition 48 includes a reader/writer unit 90 on its rear surface. The reader/writer unit 90 is electrically connected to the dust collection controller 44. The lid 73 includes an information storage 91, such as an IC tag, on its rear surface in front of the reader/writer unit 90. Information used for the control may be obtained in this manner. This reading mechanism allows accurate determination on the use time of the filter 78. The reading mechanism also allows easy identification of the type and the performance of the filter 78 or the specifications of the dust collection attachment, in addition to determination on the remaining service life.

The dust removal mechanism may include a motor or a cam for dust removal, instead of a solenoid, to directly strike the dust box.

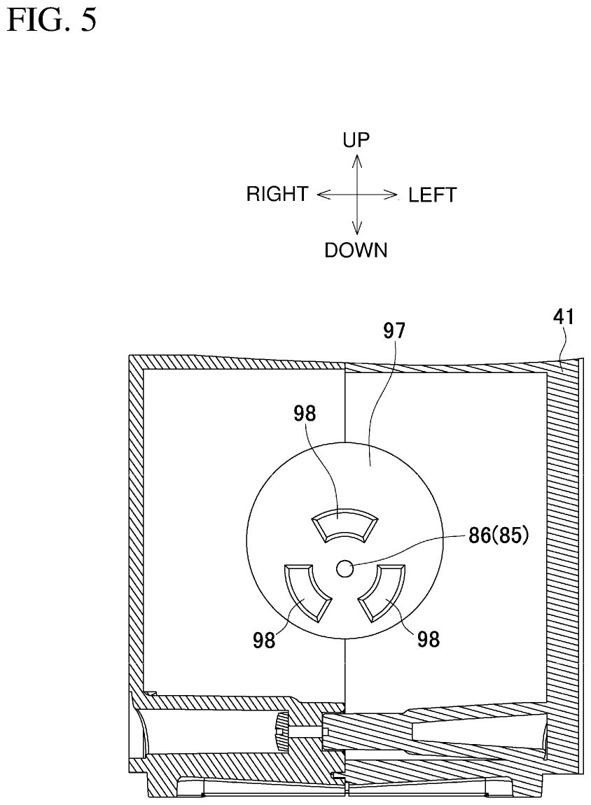

As shown in FIGS. 4 and 5, the output shaft 43 of the dust collection motor 42 is elongated rearward to receive an engagement plate 95 having a recess 96 on its rear surface in a fixed manner. The plunger 86 in the solenoid 85 located behind the engagement plate 95 may receive an unbalanced weight 97 in a fixed manner. The unbalanced weight 97 includes, on its front surface, a protrusion 98 fitted with the recess 96. In this case, the solenoid 85 energized causes the plunger 86 to advance forward together with the unbalanced weight 97, allowing the protrusion 98 to be engaged with the recess 96. The recess 96 rotates together with the output shaft 43. The engagement between the protrusion 98 and the recess 96 generates vibrations on the output shaft 43. The vibrations are transmitted from the casing 41 to the dust box 70. This causes the filter 78 to vibrate to remove dust off the filter 78.

The dust removal mechanism including the unbalanced weight 97 engaged with the output shaft 43 of the dust collection motor 42 vibrates the filter 78 as described above. This mechanism uses rotation of the output shaft 43 to intensely vibrate the filter 78.

In some embodiments, the hammer drill may include a motor oriented differently or a motor of a different type or battery packs arranged differently as appropriate. The hammer drill may be powered by alternating current (AC) and may include a power cord, instead of battery packs. The dust collection attachment may also have any structure for connection to the hammer drill, any arrangement of the dust box, and any structure for connection of the dust box other than those described in the above embodiment.

The present invention is applicable not only to a hammer drill but also to other power tools to which such a dust collection attachment is connected, such as an electric drill and an electric hammer.

### REFERENCE SIGNS LIST

1 hammer drill
2 housing
3 motor
4, 43 output shaft
6 countershaft
10 tool holder
19 switch
20 switch lever
24 controller
25 wireless unit
30 attachment portion
40 dust collection attachment
41 casing
42 dust collection motor
44 dust collection controller
45 dust collection fan
46 air inlet chamber
47 connecting portion
49 communication hole
50 pressure sensor
52 indicator lamp
59 slide cylinder
60 nozzle
61 suction port
62 flexible hose
70 dust box
71 box body
73 lid
77 filter compartment
78 filter
85 solenoid
86 plunger
88 dust removal switch
90 reader/writer unit
91 information storage
95 engagement plate
97 unbalanced weight
S dust collection system
B bit
R dust collection path

What is claimed is:

1. A dust collection attachment connectable to a power tool, the attachment comprising:
a dust collection motor configured to generate a suction force;
a filter configured to catch sucked dust;
a dust removal mechanism configured to remove dust accumulating on the filter; and
a control unit configured to control an operation of the dust collection motor and the dust removal mechanism, and activate the dust removal mechanism when a predetermined condition is satisfied.

2. The dust collection attachment according to claim 1, wherein
the control unit activates the dust removal mechanism when the suction force is lower than or equal to a predetermined value.

3. The dust collection attachment according to claim 1, wherein
the control unit activates the dust removal mechanism after stopping the dust collection motor.

4. The dust collection attachment according to claim 1, wherein
the control unit activates the dust removal mechanism in accordance with a remaining service life of the filter.

5. The dust collection attachment according to claim 1, wherein
the dust removal mechanism is a solenoid configured to vibrate the filter when energized.

6. The dust collection attachment according to claim 1, wherein
the dust removal mechanism is an unbalanced weight engaged with an output shaft of the dust collection motor to vibrate the filter.

7. The dust collection attachment according to claim 5, further comprising:
a dust removal switch configured to activate the dust removal mechanism at an intended time.

8. The dust collection attachment according to claim 2, wherein
the control unit activates the dust removal mechanism after stopping the dust collection motor.

9. The dust collection attachment according to claim 2, wherein
the control unit activates the dust removal mechanism in accordance with a remaining service life of the filter.

10. The dust collection attachment according to claim 3, wherein
the control unit activates the dust removal mechanism in accordance with a remaining service life of the filter.

11. The dust collection attachment according to claim 2, wherein
the dust removal mechanism is a solenoid configured to vibrate the filter when energized.

12. The dust collection attachment according to claim 3, wherein
the dust removal mechanism is a solenoid configured to vibrate the filter when energized.

13. The dust collection attachment according to claim 4, wherein
the dust removal mechanism is a solenoid configured to vibrate the filter when energized.

14. The dust collection attachment according to claim 2, wherein
the dust removal mechanism is an unbalanced weight engaged with an output shaft of the dust collection motor to vibrate the filter.

15. The dust collection attachment according to claim 3, wherein
the dust removal mechanism is an unbalanced weight engaged with an output shaft of the dust collection motor to vibrate the filter.

16. The dust collection attachment according to claim 4, wherein
the dust removal mechanism is an unbalanced weight engaged with an output shaft of the dust collection motor to vibrate the filter.

17. The dust collection attachment according to claim 6, further comprising:
a dust removal switch configured to activate the dust removal mechanism at an intended time.

18. A dust collection system for a power tool, the system comprising:
a power tool; and
the dust collection attachment according to claim 1 connected to the power tool.
